(19) United States
(12) Patent Application Publication
(10) Pub. No.: US 2008/0136219 A1
(43) Pub. Date: Jun. 12, 2008

(54) Over-molded water channel

(75) Inventors: Larry Berryhill, Livonia, MI (US); Adam Kyle Cramton, Royal Oak, MI (US); Anil Kumar, Bangalore (IN)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/589,536

(22) Filed: Oct. 30, 2006

(51) Int. Cl. B60J 7/00

(52) U.S. Cl. 296/213; 296/216.09

(57) ABSTRACT

A water channel for a window panel in a sunroof includes a secondary seal that is used to capture fluid that bypasses a primary seal. The secondary seal is over-molded onto the water channel and serves to direct bypassing fluid into the water channel. The secondary seal is made from a pliant material and is in an upright position when the window panel is closed to direct fluid into the water channel. The secondary seal moves to a collapsed position when the window panel is moved into an open position.

### TECHNICAL FIELD

The present invention relates to a water channel for a sunroof that includes a secondary sealing member.

### BACKGROUND OF THE INVENTION

Vehicle sunroofs include a window panel that is moveable between a closed position and an open position. A seal is positioned between a rear edge of the window panel and a roof structure, and serves to prevent fluid from entering a passenger compartment when the window panel is in the closed position.

Under high pressure conditions, such as when a vehicle is driven through a car wash for example, the window panel may deflect in a downward direction against the seal. This movement can correspondingly cause the seal to deflect, allowing fluid to bypass the seal and enter the passenger compartment.

One proposed solution includes allowing the water channel to tilt upwardly when the window panel is in the closed position to capture fluid that bypasses the seal. However, this adds extra structure and associated cost to the sunroof.

Another proposed solution has been to design the seal and associated components to have a tighter fit. However, utilizing a tighter fit at this interface can cause undesirable squeaking and rattling.

Thus, there is a need for an improved seal for a sunroof that can withstand high pressure conditions, will not generate undesirable noises, and which is not cost prohibitive.

### SUMMARY OF THE INVENTION

A water channel for a sunroof includes a secondary seal member that serves to direct fluid into the water channel if the fluid bypasses a primary seal.

A primary seal is positioned between a rear edge of a window panel and a roof structure when the window panel is in a closed position. The primary seal generally prevents fluid from entering a passenger compartment. However, during high fluid pressure conditions where fluid may bypass the primary seal, the secondary seal captures the bypassing fluid and directs it into the water channel.

In one disclosed example, the secondary seal is fixed directly to the water channel to direct bypassing fluid into the water channel. The secondary seal is made from a pliant material that is over-molded onto a portion of the water channel. The secondary seal is movable between an upright position and a collapsed position. When in the upright position, the secondary seal serves to capture and direct the bypassing fluid into the water channel. The secondary seal moves into the collapsed position in response to contact by the window panel as the window panel moves to an open position.

In one disclosed example, an over-molded portion of the secondary seal includes a protruding nub that is used to dampen noise. The protruding nub extends outwardly to contact a guide member that moves the water channel. As the protruding nub is also made from the pliant material, noise is reduced at this contact interface between the nub and the guide member.

These and other features of the present invention can be best understood from the following specification and drawings, the following of which is a brief description.

### BRIEF DESCRIPTION OF THE DRAWINGS

FIG. 1 is a perspective view of a sunroof assembly incorporating the subject invention.

FIG. 2A is a cross-sectional view of the sunroof assembly of FIG. 1 installed in a vehicle roof with the sunroof assembly being in a closed position.

FIG. 2B is similar to FIG. 2A but shows the sunroof assembly moving to an open position.

FIG. 3 is an overhead view of a portion of a water channel and seal of the sunroof assembly of FIG. 1.

### DETAILED DESCRIPTION OF THE PREFERRED EMBODIMENT

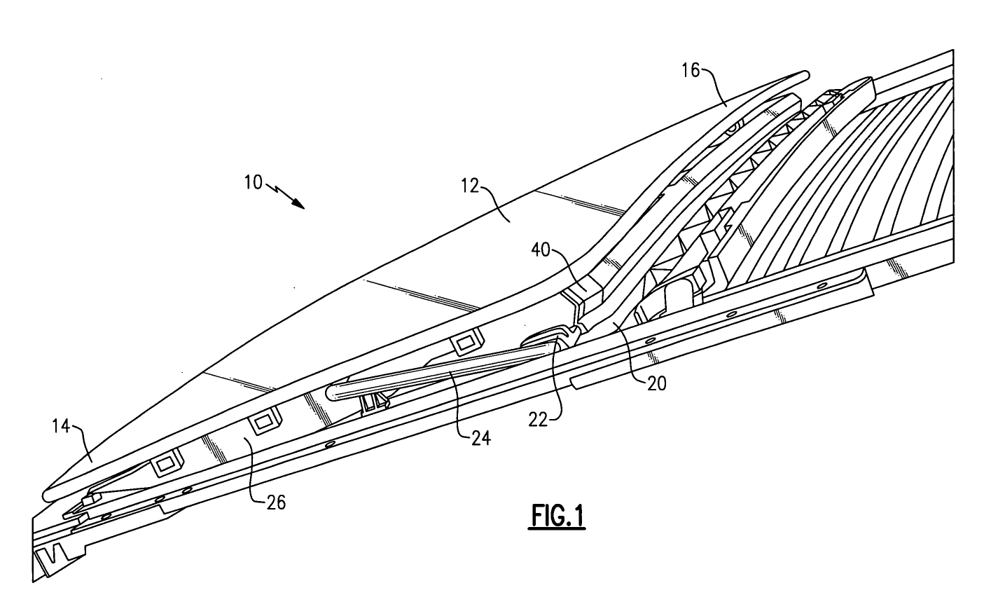

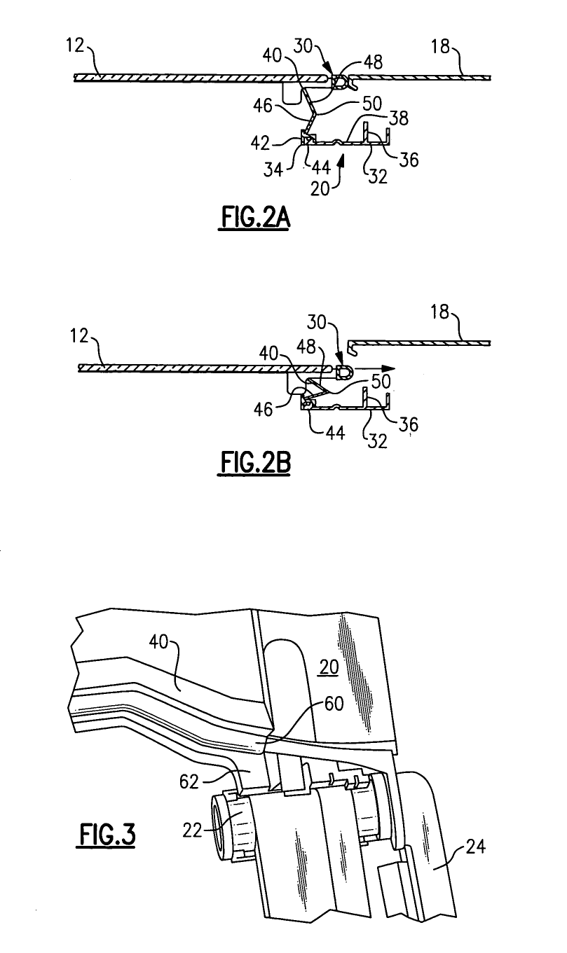

A sunroof assembly 10 is shown generally at 10 in FIG. 1. The sunroof assembly includes a window panel 12 that has a forward edge 14 and a rearward edge 16. The forward edge 14 extends toward the front of a vehicle and the rearward edge 16 extends toward the rear of the vehicle. The window panel 12 moves relative to a roof structure 18 (FIGS. 2A-2B) in a longitudinal direction between an open position and a closed position.

A water channel 20 extends in a lateral direction adjacent the rearward edge 16 of the window panel 12. The water channel 20 captures water and other fluids, etc., to prevent their entry into a passenger compartment. The water channel 20 directs water to drains (not shown) as known, which allow the water to be expelled to the external environment. The water channel 20 is mounted for movement with the window panel 12 in the longitudinal direction. A retaining hook guide 22 couples the water channel 20 to a connecting arm 24. The connecting arm 24 is coupled to other sunroof components that are used to move the window panel 12 along a guide structure 26 as known.

As shown in FIG. 2A, a primary seal 30 is positioned between the roof structure 18 and the rearward edge 16 of the window panel 12 when the window panel 12 is in the closed position. As shown, when in the closed position, the window panel 12 forms part of an outer skin of the vehicle. The primary seal 30 serves to prevent fluids from entering the passenger compartment when the window panel 12 is in the closed position.

The water channel 20 is positioned to extend underneath the primary seal 30 and rearward edge 16 of the window panel 12 when the window panel 12 is in the closed position. The water channel 20 includes a channel body 32 with a first wall 34, a second wall 36, and a trough 38 for capturing fluid that is positioned between the first 34 and second 36 walls.

The water channel 20 includes a secondary seal 40 that is molded onto the water channel 20. The secondary seal 40 includes an over-mold portion 42 that is molded over a protrusion 44 formed on the water channel 20. In the example shown, the protrusion 44 is formed along the first wall 34 of the channel body 32. The secondary seal 40 is formed from a resilient or pliant material and the water channel 20 is formed from a rigid material, such as plastic for example. The pliant material is over-molded onto the rigid material to securely attach the secondary seal 40 to the water channel 20.

When the vehicle is driven through a car wash for example, the primary seal 30 may not be able to withstand high fluid pressure forces. These high fluid pressure forces can deflect the window panel 12 allowing fluid to bypass the primary seal 30. The secondary seal 40 serves to direct this bypassing fluid into the water channel 20 to prevent the bypassing fluid from entering the passenger compartment. As shown in the example configuration of FIG. 1, the secondary seal 40 extends only along the rearward edge 16 of the window panel 12.

In the example shown in FIGS. 2A-2B, the secondary seal 40 is formed to have a V-shaped cross-section with a first leg 46 and a second leg 48 connected to each other at a vertex 50. A distal end of the first leg 46 includes the over-mold portion 42 that is molded onto the protrusion 44. The distal end of the second leg 48 is vertically spaced apart from the distal end of the first leg 46 when the window panel is in the closed position as shown in FIG. 2A. In this configuration, the vertex 50 extends in a rearward direction.

The secondary seal 40 is formed from a pliant or resilient material such that the secondary seal 40 is movable between an extended position and a collapsed position. In FIG. 2A, where the window panel 12 is in a closed position, the secondary seal 40 is in the extended position where the first 46 and second 48 legs cooperate to capture and direct bypassing fluid into the trough 38.

In FIG. 2B, the secondary seal 40 is in the collapsed position. The secondary seal 40 collapses in response to contact by the window panel 12, and/or components associated with the window panel 12, as the window panel 12 moves into the open position. Because the secondary seal 40 collapses upon contact during opening, packaging constraints are easily met for the window panel 12 dropping downward to retract underneath the roof structure 18 as the window panel 12 moves to the open position.

Another feature of the secondary seal 40 is shown in FIG. 3. As discussed above, the secondary seal 40 extends generally in a lateral direction underneath the rearward edge 16 of the window panel 12. At least one lateral end 60 of the secondary seal 40 includes a nub 62 that protrudes in a generally longitudinal direction. The nub 62 is integrally formed with the secondary seal 40.

The nub 62 extends to contact the retaining hook guide 22 as shown in FIG. 3. The water channel 20 is connected to the retaining hook guide 22, which serves to move the water channel 20 back and forth with the window panel 12 via the connecting arm 24. As the protruding nub 62 is also made from the pliant material, noise is reduced at this contact interface between the nub 62 and the retaining hook guide 22.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A sunroof seal assembly comprising:
a water channel body; and
a pliant seal fixed to and extending along at least a portion of said channel body, said pliant seal being movable between an upright position when a sunroof panel is in a closed position and a collapsed position when the sunroof panel is an open position.

2. The sunroof seal assembly according to claim 1 wherein said water channel body is positioned to extend across a rear portion of the sunroof panel and wherein said pliant seal is fixed to said water channel body to extend only along the rear portion of the sunroof panel.

3. The sunroof seal assembly according to claim 2 including a primary seal member mountable between a roof edge and the rear portion of the sunroof panel, and wherein said pliant seal comprises a secondary seal member that directs fluid that bypasses said primary seal member into said water channel body when in said upright position.

4. The sunroof seal assembly according to claim 1 wherein said water channel body includes a first wall and a second wall, said first wall including a protrusion, and wherein said pliant seal includes an over-mold portion that is molded onto said protrusion.

5. The sunroof seal assembly according to claim 4 wherein said over-mold portion extends in a lateral direction along said water channel body, and wherein said over-mold portion includes a protruding nub that extends in a longitudinal direction, said protruding nub abutting against a guide component that is adapted to move the water channel body.

6. A sunroof assembly comprising:
a window panel to be movable relative to a roof structure between an open position and a closed position, said window panel having a forward edge and a rearward edge;
a guide structure mountable to the roof structure to guide said window panel between said open and said closed positions;
a first seal to be positioned between said rearward edge of said window panel and an edge of the roof structure to prevent fluid from entering a passenger compartment when said window panel is in said closed position; and
a water channel positioned to extend along said rearward edge of said window panel, said water channel including a second seal that is movable between an upright position and a collapsed position, wherein said second seal directs fluid that bypasses said first seal into said water channel when in said upright position and wherein said second seal moves to said collapsed position as said window panel moves into said open position.

7. The sunroof assembly according to claim 6 wherein said second seal is comprised of a pliant material having an over-mold portion that is over-molded onto a portion of said water channel.

8. The sunroof assembly according to claim 7 wherein said water channel includes a first wall and a second wall with a protruding portion extending outwardly from said first wall, and wherein said over-mold portion is molded onto said protruding portion.

9. The sunroof assembly according to claim 6 wherein said window panel is movable in a longitudinal direction and wherein said water channel extends along said rearward edge of said window panel in a lateral direction, and wherein said water channel includes structure for attachment to said window panel such that said water channel moves with said window panel in said longitudinal direction.

10. The sunroof assembly according to claim 6 wherein said second seal is positioned vertically below said first seal when said window panel is in said closed position.

11. The sunroof assembly according to claim 6 wherein said second seal moves to said collapsed position in response to contact by said window panel as said window panel moves to said open position.

12. The sunroof assembly according to claim 6 wherein said second seal includes a V-shaped cross-section having first and second legs interconnected to each other at a vertex, and wherein a distal end of said first leg is fixed to said water channel with a distal end of said second leg being vertically spaced apart from said distal end of said first leg.

13. A method for sealing a sunroof assembly comprising:
(a) providing a primary sunroof seal mountable between a rear edge of a window panel and a roof structure; and
(b) fixing a secondary sunroof seal to a water channel positioned to extend along the rear edge of the window panel.

14. The method according to claim 13 wherein step (b) includes molding the secondary sunroof seal onto the water channel.

15. The method according to claim 14 including providing the water channel with a first wall having a protrusion, and over-molding the secondary sunroof seal onto the protrusion.

16. The method according to claim 13 wherein the secondary sunroof seal is comprised of a pliant material and the water channel is comprised of a rigid material, and wherein step (b) includes molding the pliant material onto the rigid material.
